(19) United States
(12) Patent Application Publication
(10) Pub. No.: US 2007/0150371 A1
(43) Pub. Date: Jun. 28, 2007

(54) ONLINE MENU AND FOOD PREPARATION SYSTEMS AND METHODS

(76) Inventor: Arif Gangji, Thornton, CO (US)

Correspondence Address: TRENNER LAW FIRM, LLC, 12081 WEST ALAMEDA PARKWAY #163, LAKEWOOD, CO, 80228, US

(21) Appl. No.: 11/567,714

(22) Filed: Dec. 6, 2006

Related U.S. Application Data
(60) Provisional application No. 60/748,392, filed on Dec. 8, 2005.

(51) Int. Cl. G06Q 30/00

(52) U.S. Cl. 705/26

(57) ABSTRACT

Online menu and food preparation systems and methods are disclosed. In an exemplary embodiment, a method may comprise assisting an owner of a kitchen business to at least partially customize the plurality of customer screens. The method may also comprise using the customer screens to assist a customer of the kitchen business to build a meal online. The method may also comprise using the customer screens to schedule a session for the customer to come prepare the meal at a physical location of the kitchen business.

### PRIORITY APPLICATION

This application claims priority to co-owned U.S. Provisional Patent Application Ser. No. 60/748,392 for “Online Menu and Food Preparation Systems and Methods” of Arif Gangji, filed Dec. 8, 2006, hereby incorporated by reference in its entirety as though fully set forth herein.

### TECHNICAL FIELD

The described subject matter relates to computer software in general, and more particularly to online menu and food preparation systems and methods.

### BACKGROUND

As schedules become increasingly busier, there is little time left for traditional home-cooked meals. The restaurant industry has filled part of this need by offering sit-down, drive-through, and even take-home meals. However, restaurant means are often expensive and not as healthy as many people would like. In addition, many people still prefer home-cooked means.

Accordingly, the so-called “Meal Assembly,” “Fix and Freeze,” and “Do-It-Yourself Home Meal Preparation” industry has become increasingly popular. This industry provides stores configured as kitchens where customers can go to prepare several days, or even several weeks-worth of meals, and then take these meals home to heat up and serve.

These kitchens typically need to stay well-stocked with all of the ingredients for a wide variety of meals, and take advance orders so that customers can prepare meals to their liking. Accordingly, there exists a need for the owners of these kitchens to take orders, track inventory, and manage other aspects of the business. Where the owner has multiple kitchen locations and/or franchises, this need is even higher.

### SUMMARY

In an exemplary embodiment a system for online menu and food preparation may comprise a database for storing and retrieving data related to a kitchen business. A host computer is operatively associated with the database. Program code executes at least in part on the host computer. The program code displays a plurality of customer screens based at least in part on the data stored in the database and at least in part on data received from a customer. The plurality of customer screens assists the customer to build a meal online and schedule a session for the customer to come prepare the meal at a physical location of the kitchen business.

In an exemplary embodiments, a method for online menu and food preparation may comprise assisting an owner of a kitchen business to at least partially customize the plurality of customer screens, using the customer screens to assist a customer of the kitchen business to build a meal online, and using the customer screens to schedule a session for the customer to come prepare the meal at a physical location of the kitchen business.

In an exemplary embodiment, a computer-program product for online menu and food preparation may comprise program code for storing and retrieving data in a database program code for receiving data from a customer; program code for displaying a plurality of customer screens based at least in part on the data stored in the database and at least in part on data received from a customer, the plurality of customer screens assisting the customer to build a meal online; and program code for scheduling a session for the customer to come prepare the meal at a physical location of the kitchen business.

### BRIEF DESCRIPTION OF THE DRAWINGS

FIG. 1 is a high-level diagram of an exemplary computer network which may be implemented for online menu and food preparation.

FIG. 2 is an exemplary browser interface which may be implemented for online menu and food preparation.

FIGS. 3-10 are screenshots showing exemplary input/output that may be displayed for owner(s) in a browser interface for online menu and food preparation.

FIGS. 11-14 are screenshots showing exemplary input/output that may be displayed for customer(s) in a browser interface for online menu and food preparation.

FIG. 15 is a flowchart illustrating exemplary operations 1500 which may be implemented for online menu and food preparation.

### DETAILED DESCRIPTION

Online menu and food preparation systems and methods are disclosed. In exemplary embodiments, the systems and methods facilitate the so-called “Meal Assembly,” “Fix and Freeze,” and “Do-IT-Yourself Home Meal; Preparation” industry (also referred to generally herein as the “kitchen” or the “kitchen business”).

In exemplary embodiments, the systems and methods may be implemented as an “out of the box” integrated software product that reduces development time for store owners. For example, the software product may be implemented as a custom web-based (or other computer network) application that may be accessed by any operating system (OS) connected to a private network or public network (such as the Internet). The system may be executed on any computer or array of computers, and may be accessed via any electronic device (e.g., personal computer, personal digital assistant or “PDA,” mobile phone, etc.). Optionally, the software product may be used by multiple store locations and managed from a single location (e.g., by the store owner).

The software product may be completely integrated as a single package including features such as, e.g., inventory, marketing, operations, ordering, delivery, and franchise development/tracking. Other features may include, but are not limited to, integrated online ordering and order management, ROI/marketing/order tracking, operations management, reporting, and franchise management and integration.

The software product can be customized or changed to suit a particular business and/or branding. The software product may also be designed for franchises to save time, make it easy to sign up, and create a solid software platform to run and grow business.

Exemplary Systems

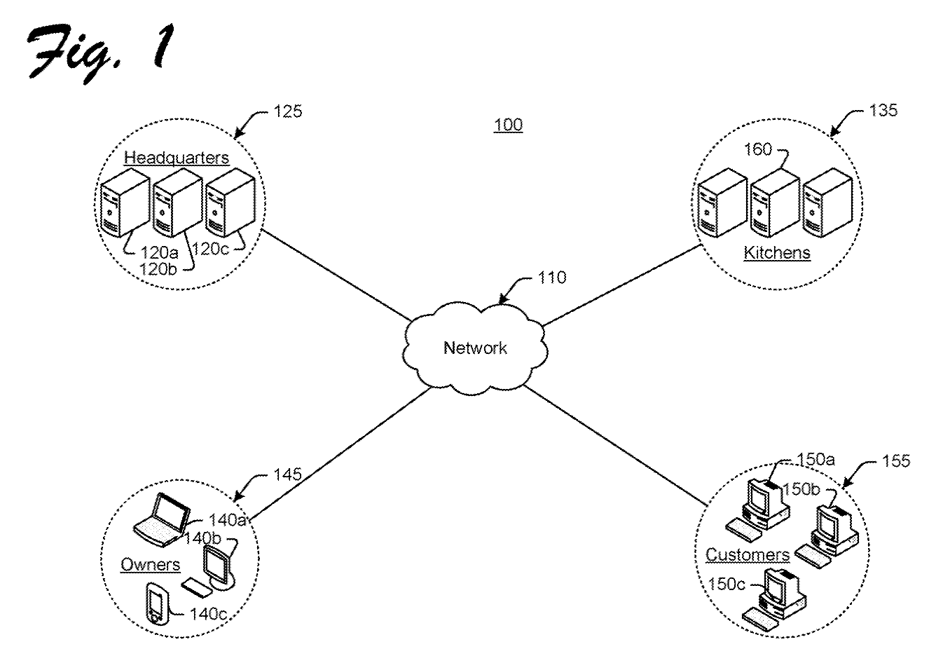

FIG. 1 is a high-level illustration of an exemplary networked computer system 100 (e.g., via the Internet) which may be implemented for online menu and food preparation systems and methods. The networked computer system 100 may include one or more communication networks 110, such as a local area network (LAN) and/or wide area network (WAN), for connecting one or more headquarters 125, one or more kitchens 135, one or more owners 145, and one or more customers 155.

The operations described herein may be implemented by host computers and client computers in the networked computer system 100. For purposes of illustration, host computers 120a-c are shown in the networked computer system 100 for headquarter(s) 125 (e.g., for managing multiple kitchens, such as multiple locations and/or franchises), and host computers 130a-c are shown for kitchen(s) 135. Also for purposes of illustration, client computers 140a-c are shown in the networked computer system 100 for owner(s) 145, and client computers 150a-c are shown for an customer(s) 155.

Host computers (or “hosts”) may include one or more computing systems, such as a server with computer-readable storage. The hosts may be provided on the network 110 via a communication connection, such as a dial-up, cable, or DSL connection via an Internet service provider (ISP). The hosts may be accessed directly via the network 110, or via a network site. In an exemplary embodiment, the network site may also include a web portal on a third-party venue (e.g., a commercial Internet site), which facilitates a connection for one or more clients with host (e.g., via a back-end link). In another exemplary embodiment, portal icons may be provided (e.g., on third-party venues, pre-installed on computer or appliance desktops, etc.) to facilitate a direct link to the host.

Hosts may execute the software product, as described in more detail below. The hosts may also provide services to other computing or data processing systems or devices. For example, hosts may also provide transaction processing services, email services, etc.

The term “client” as used herein refers to a computing device through which one or more owners 145 or customers 155 (e.g., administrators) may access the network 110. Clients may include any of a wide variety of computing systems, such as a stand-alone personal desktop or laptop computer (PC), workstation, personal digital assistant (PDA), or appliance, to name only a few examples. Each of the client computing devices may include memory, storage, and a degree of data processing capability at least sufficient to manage a connection to the network 110, either directly or indirectly. Client computing devices may connect to network 110 via a communication connection, such as a dial-up, cable, or DSL, connection via an Internet service provider (ISP).

As mentioned above, the hosts at one or more kitchens 135 and/or headquarters 125 may execute the software package. The software product is described in more detail below with reference to a web-based user interface. It is noted that the data and content shown in the Figures may be updated automatically by the host (depending on user selection), thereby further reducing wait time that would otherwise be needed for a web developer to make changes. Accordingly, the software product reduces costs to the owners of the kitchens by not having to hire a web developer to make changes to menus, kitchens, content, etc.

It is noted that the terms “headquarters,” “kitchens,” “owners,” and “customers” are used to designate different entities in an online food preparation and menu system. For example, an “owner” or “owners” may be the actual kitchen business owner himself or herself, or the “owner” or “owner” may be an employee, agent, representative, etc. for the owner. These terms are used to facilitate recognition of the different entities only and are not intended to be limiting.

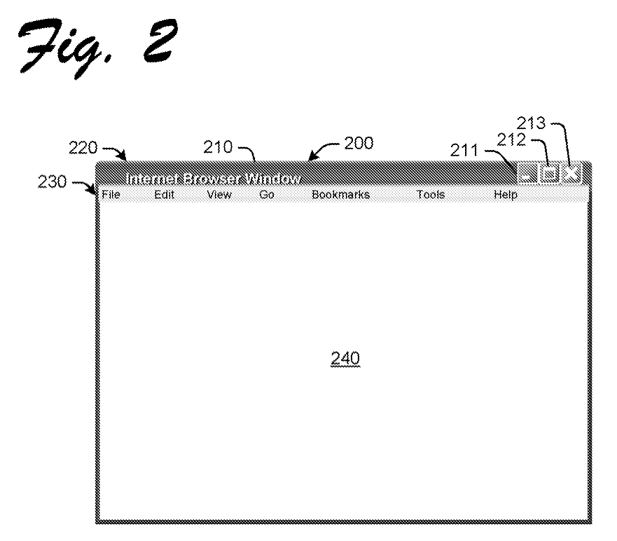

FIG. 2 is an exemplary browser interface 200 (e.g., Internet Explorer, Firefox Mozilla, etc.) which may be implemented for online menu and food preparation. The browser interface enables owners 145 to interface with the software product as described in more detail below, e.g., to set up and manage online food preparation and menu services for the kitchen(s) 135. The browser interface also enables customers 155 to interface with the software product as described in more detail below, e.g., to select menus and schedule cooking times.

In an exemplary embodiment, the browser interface 200 may be implemented as a graphical user interface (GUI) in a “windows-based” operating system environment (e.g., Microsoft Corporation's WINDOW®), although the browser interface 200 is not limited to use with any particular operating system. The user may launch the browser interface 200 in a customary manner, for example, by clicking on an icon, selecting the program from a menu, or pressing a key on a keyboard.

The browser interface 200 supports user interaction through common techniques, such as a pointing device (e.g., mouse, style), keystroke operations, or touch screen. By way of illustration, the user may make selections using a mouse to position a graphical pointer and click on a label or button displayed in the browser interface 200. The user may also make selections by entering a letter for a menu label while holding the ALT key (e.g., “ALT+letter” operation) on a keyboard. In addition, the user may use a keyboard to enter command strings (e.g., in a command window).

The browser interface 200 is displayed for the user in a window, referred to as the “application window” 210, as is customary in a window environment. The application window 210 may include customary window functions, such as a Minimize Window button 211, a Maximize Window button 212, and a Close Window button 213. A title bar 220 identifies the application window 210 for the user (e.g., as “Internet Browser Window”). The application window 210 may also include a customary menu bar 230 having an assortment of pull down menus (e.g., labeled “File,” “Edit,” “View,” “Go,” “Bookmarks,” “Tools,” and “Help”), which are well-known in commercially available browser interfaces 200. For example, the user may select a print function (not shown) from the “File” menu (designated herein as “File|Print”).

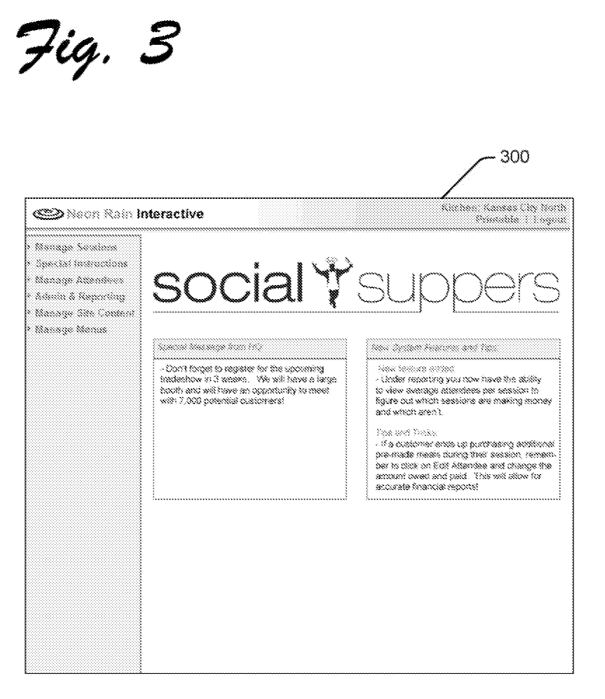

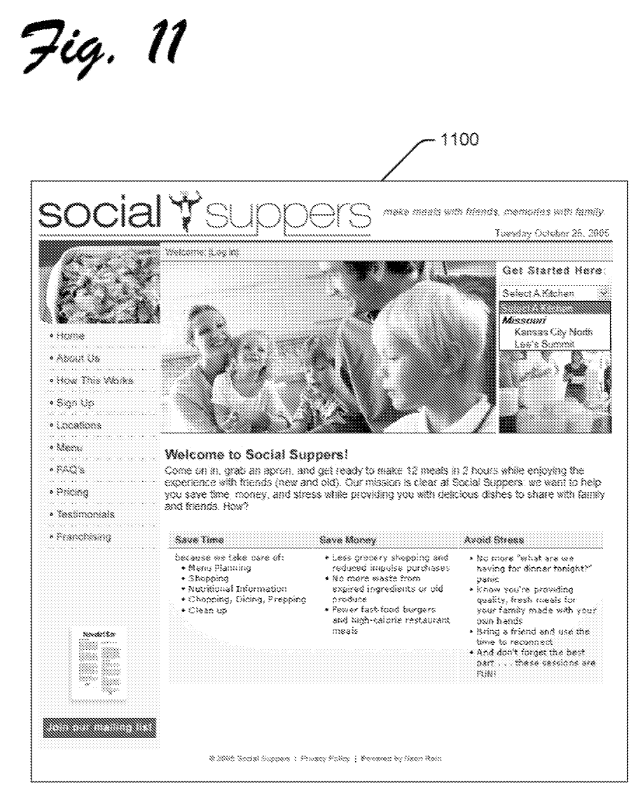

Application window 210 also includes an operation space 240. Operation space 240 may include one or more graphics for displaying output and/or facilitating input from the user. Although not shown, the graphics may also include, but are not limited to, subordinate windows, dialog boxes, icons, text boxes, buttons and check boxes. Exemplary input/output for operation space 240 is described in more detail below with reference to the exemplary owner screens shown in FIGS. 3-10 and the exemplary customer screens shown in FIGS. 11-14.

FIGS. 3-10 are screenshots showing exemplary input/output that may be displayed for owner(s) in a browser interface for online menu and food preparation. The input/output enables the owner(s) to setup and manage one or more kitchens. It is noted that the exemplary input/output is merely illustrative and not intended to be limiting. Other embodiments for input/output are also contemplated for implementing online food preparation and menu systems, as will be readily apparent to those having ordinary skill in the art after becoming familiar with the teachings herein.

FIG. 3 is a screenshot showing an exemplary Administrative Console 300. This is the main “landing area” for owners, and may include for example, an area to post special messages from headquarters (e.g., for franchises), an area to notify kitchens of new features that are available, an area to assist kitchens with “Tips and Tricks” for maximum usability and efficiency.

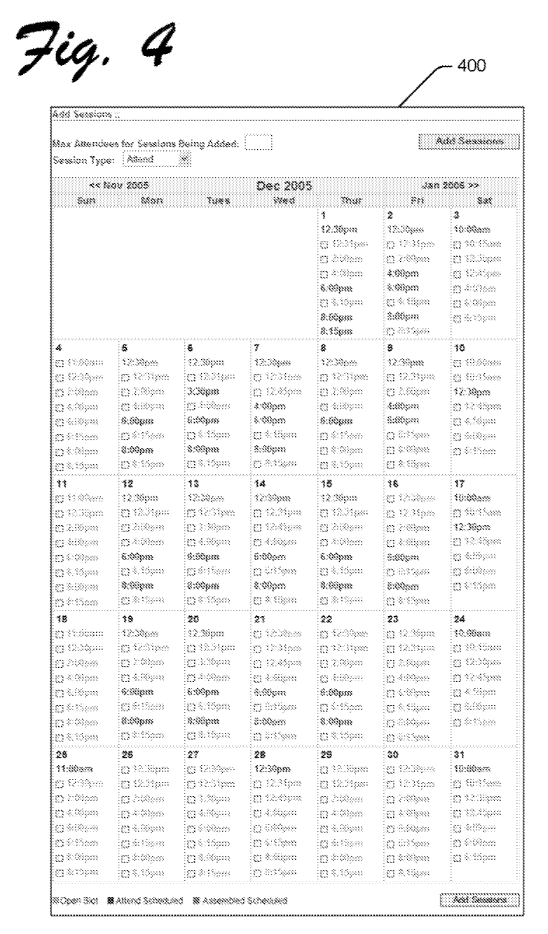

FIG. 4 is a screenshot showing an exemplary Add session area. Here, owners may add different types of sessions very quickly by entering the maximum number of attendees for the session, the type of session, and then clicking on session timeslots and clicking on Add Sessions. In exemplary embodiments, the owner may add a month's worth of sessions within seconds.

It is also noted that timeslots may be customized through another area in the Administrator Console. In addition, the Session Type may also be customized based on whether the kitchen is offering different types of meals, delivery, pre-made meals, etc. Other features may also be implemented.

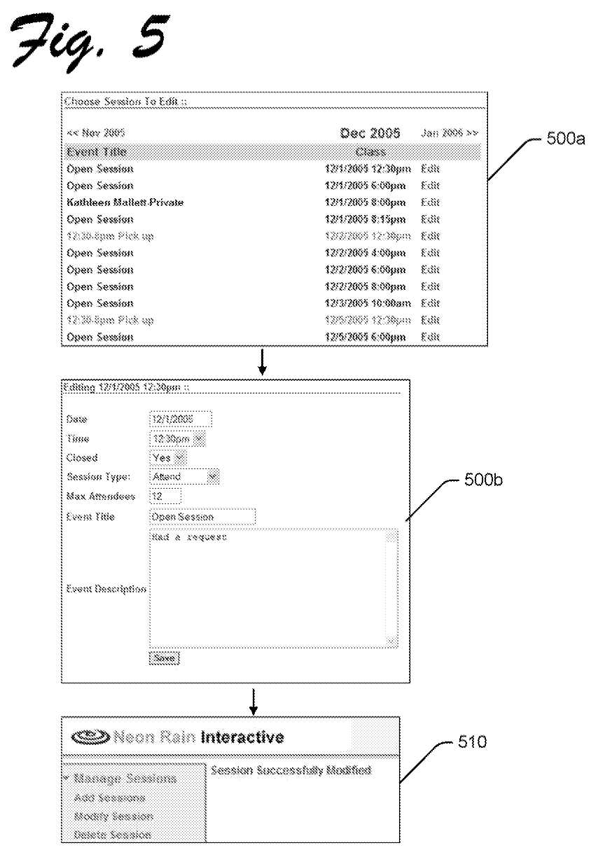

FIG. 5 is a screenshot showing an exemplary Edit session dialog boxes 500a-b that may be used after a session has already been created. For example, the owner may change Session Date, Session Time, whether the session is open for reservations (or not), Type of sessions maximum number of attendees, and give the session a title and/or a description.

Optionally, the owner may open an event management area (not shown) to set a session as e.g., a baby shower. The owner can then setup the baby shower by selecting the Mother and the person throwing the shower, the Sex of the baby (e.g. the colors on the baby shower sign-in page change based on the Sex of the baby between Pink/Blue/Yellow). Once set up, guests may sign in and provide their email address. The list is imported into the Kitchen's newsletter database to keep track of guests. A copy of the list may be emailed to the Mother for archival purposes.

It is noted that the owner nay also choose to receive feedback 510 to know if the save was successful. If certain information changes that affects other areas of the site or if there are customers already signed up, there is a warning message and an opportunity to cancel without saving.

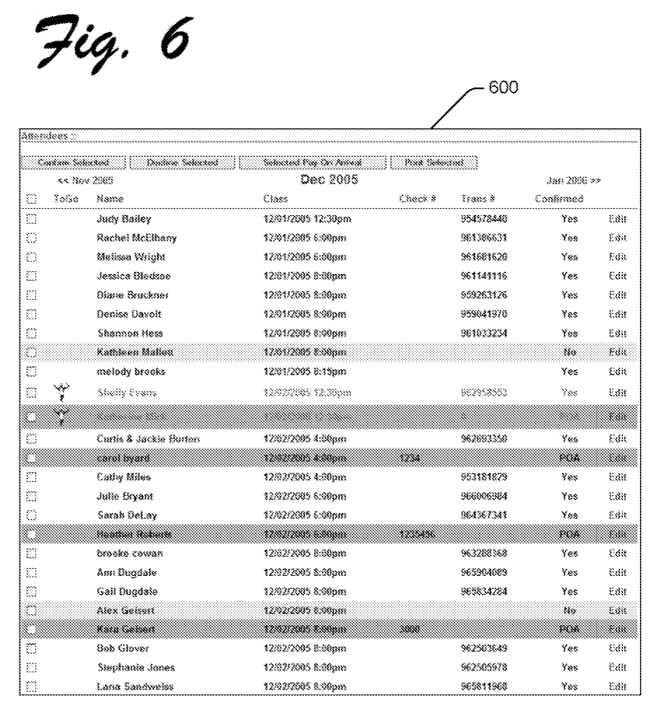

FIG. 6 is a screenshot showing an exemplary Attendee Management area 600. Here, the owner has the ability to select one many customers, or all customers at once. The owner may also confirm/decline the selected reservations. The owner may also set customers to pay on arrival or in advance. The owner is also provided the ability to quickly print Welcome menus for a full session on demand.

Optionally, color coding may be used for, e.g., different sessions, To Go orders. All Natural Meat, etc. Promo Codes, if used, may also be shown, including the number of guests the customer is bringing.

The owner may also select multiple reservations and then click on any of the buttons to execute various functions. For example, the owner may click on a button labeled Confirm Selected. The owner is then given an opportunity to Cancel or Continue and Confirm All. The user has the same option with Decline and Pay on Arrival.

The owner may also use advanced search and filter options for managing attendees at sessions and corresponding orders, utilizing date ranges, wild cards, and meal type/payment type/upgrade type filters.

The owner may also edit orders for a customer, move customers to another session, change personal information, change menu information, and order option information. The owner may also override the minimum number of meals and if the customer purchases additional items, notify the kitchen staff to charge the difference.

Before a customer arrives for a session the owner can go to the Attendee Status area, click on all the attendees for that session, click on ‘Print Selected’ and receive a new page with pre-formatted menus. The printout displays session information, menu items with check off boxes, options, amount owed (if the customer owes anything), a disclaimer, Thank You message, and notes area, in addition to the kitchen's contact information. When clicking print, the system may print one menu per page for a “pile” ready to hand out. It is noted that the printout may also optionally display suggested sides and cook time.

Optionally, the owner (or other kitchen staff) may take reservations over the phone. After finding an existing customer in the system, the owner can sign up the customer as if the customer had logged in themselves. The interface may create an account for them based on their phone number instead of email address. If a customer is not in the system and this is their first time to attend, the owner can create an account for them.

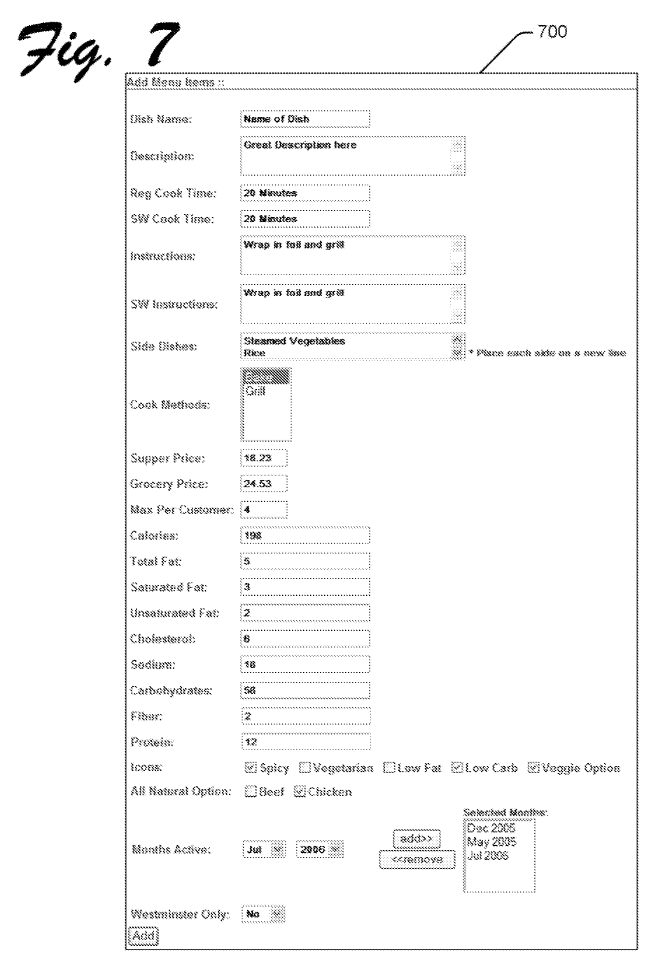

FIG. 7 is a screenshot showing an exemplary Managing Menu Items dialog box 700. In the Managing Menu Items dialog box 700, the owner can enter all information regarding a menu item, add items, set active/inactive, delete, and modify all and any of the information for menu Items. Additional ability includes, e.g., grouping menu items so that specific items show up for specific franchises during the time specified and entering a Grocery Comparison chart for customers.

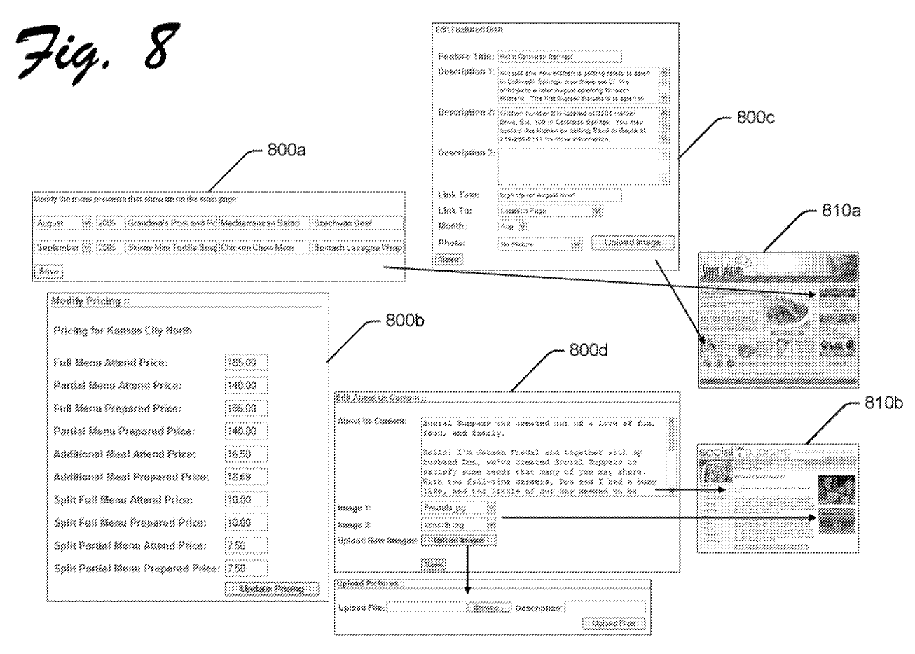

FIG. 8 is a screenshot showing exemplary Content Management dialog boxes 800a-e which may be displayed for the customer as shown by screen shots 810a-b. These dialog boxes enable the owner to customize menu preview areas, a main page Feature area, About Us content for each kitchen (including image upload), pricing for each kitchen, and different session timeslots for each kitchen and to customize the sessions for the demographic.

Optionally, an Inventory System may be integrated with menu management. That is, the software product allows owners to enter recipes which interact with customer orders and auto calculates actual foot cost, waste, and upcoming food order needs for customer menu fulfillment.

The inventory System may also track pre-frozen meals for immediate in store purchase, where customers can purchase pre-made/pre-frozen meals online based on actual quantity available in store at that moment of purchase. This results in real time data feed of inventory.

The Inventory System may also be integrated with food distribution companies, such as with Sysco Food Distributors, a global leader in selling, marketing and distributing food products. Accordingly, owners can update their inventory system automatically based on data from Sysco's web site.

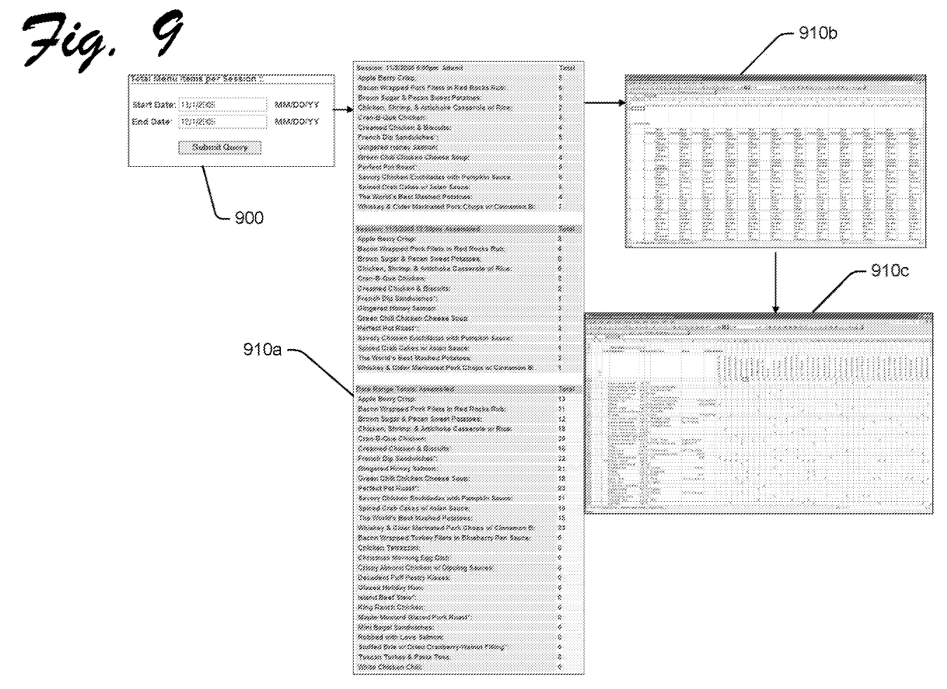

FIG. 9 is a screenshot slowing an exemplary dialog box 900 for generating exemplary Menu Total reports 910a-c. The Menu Total reports 910a-c may include the total number of each meal needed per session, enabling the kitchen staff to prepare for the proper amount of food. This report 910a-c also assists in ordering for upcoming sessions. This report may be imported into the Inventory System for monitoring current inventory as well as estimating what to order.

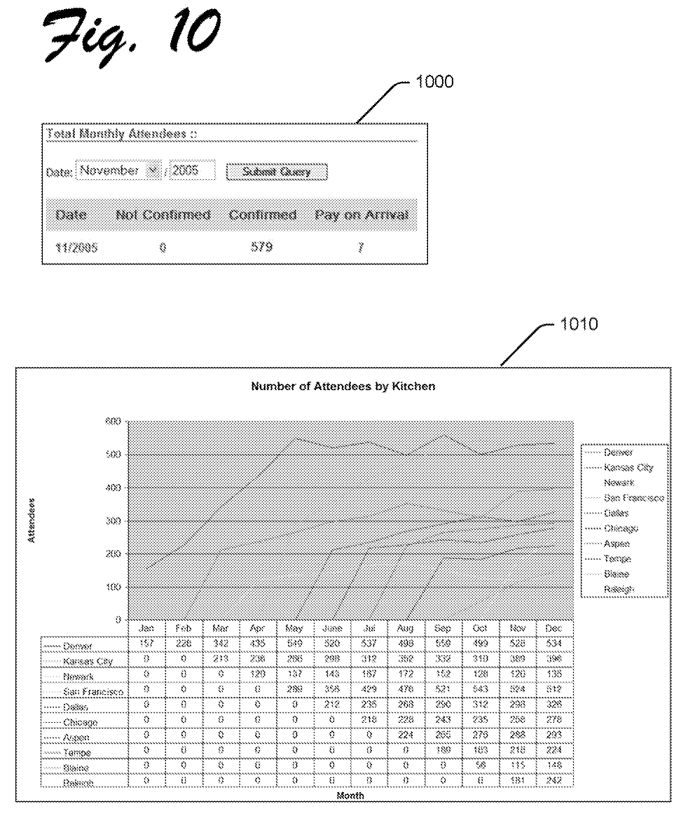

FIG. 10 is a screenshot showing an exemplary dialog box 1000 for generating an exemplary Session Average Attendance report 1010. The Session Average Attendance report 1010 enables the owner to determine which sessions are cost effective, quickly see which sessions are most attended and which are least attended, and create more sessions or remove sessions based on actual data.

Other reports may also be generated. For example an all customers report enables the owner to find past customers review customer orders and session history, create marketing lists (including mailing labels), sort (e.g., by zip code, state etc.), export data for Customer Relations Manager Software (e.g., ACT!), find out who missed last month, find out who the best customers are, etc. Other reports may enable the owner to review ratings for meal selection. As customers review meals, the owner can judge which meals quickly become favorites and which meals customers do not like. All reports may be generated by franchise or company-wide.

FIGS. 11-14 are screenshots showing exemplary input/output that may be displayed for customer(s) in a browser interface for online menu and food preparation. The input/output enables the customer(s) to select menus and schedule times to prepare meals at one or more kitchens. It is noted that the exemplary input/output is merely illustrative and not intended to be limiting. Other embodiments for input/output are also contemplated for implementing online food preparation and menu systems, as will be readily apparent to those having ordinary skill in the art after becoming familiar with the teachings herein.

FIG. 11 is a screenshot showing an exemplary front page 1100 that a customer may see when entering a website for a kitchen. Here, customers may use a drop down menu to access a specific kitchen. The customer may click on Sign Up to choose a kitchen based on State, City, etc., or click on Locations and then choose a kitchen. All of these kitchens are pulled from a database (e.g., maintained on one of the hosts) automatically. Alternatively, the customer may click on Log In to immediately log in and go a pre-selected ‘Preferred Kitchen’ (e.g., that was setup during account creation).

Optionally, the front page may have a call to action stating “Click Here to Begin,” which then enables the customer to select their Location (e.g., state) and view nearby kitchens. Again, the kitchens are pulled from the database automatically. In exemplary embodiments, the front page is fully self service. For example, if the customer forgets their password, the system automatically sends the user a new password, thereby reducing the need for customer-employee interaction.

The system may also gather data as to where the customer heard about the kitchen. This drop down is dynamically generated by the system based on where each kitchen is marketing. This feature assists the owner with tracking marketing dollars and Return on Investment (ROI). After choosing a location the Calendar of sessions is loaded.

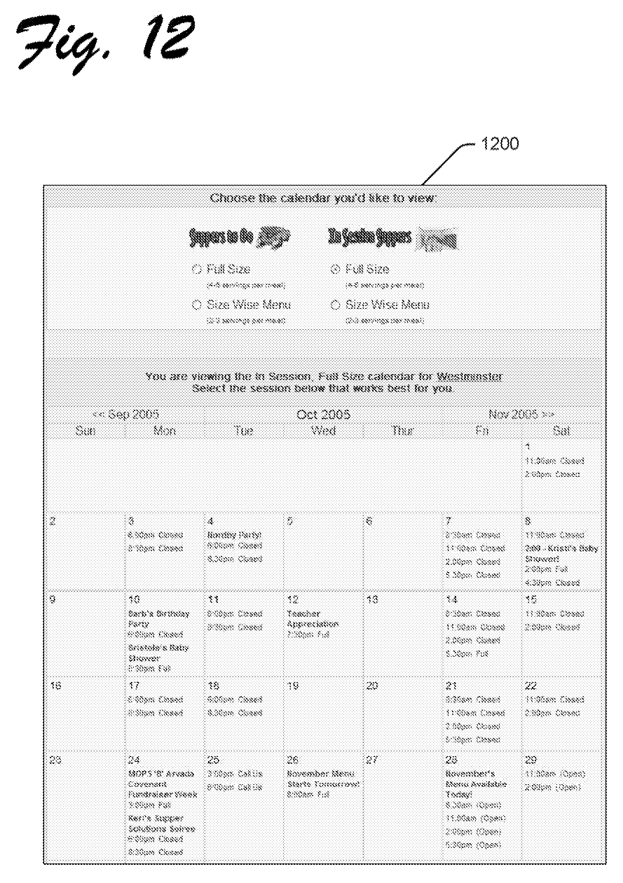

FIG. 12 is a screenshot showing an exemplary Calendar 1200 that may be displayed for a customer. The Calendar may be pulled dynamically from the database maintained by the host and may service many types of sessions. It may also automatically show the current month calendar.

The Calendar 1200 may automatically close sessions X number of hours before a session is to begin in order to give the owner sufficient preparation time (e.g., to purchase inventory). The Calendar 1200 may also be set to manually close, and to show how many spots are open.

Event titles are also available for display on the Calendar 1200. The title may either pop up a window with details, or link to the session it is tied to. Tying an event to a session is optional as well. It may be just a title and a popup or title alone.

If the customer chooses to edit an upcoming session, the drop down lists any sessions that are e.g., at least 72 hours away from the current time/date. The customer may then view menu items for that session and change quantities or items. The customer may either choose the same quantity of meals or if the kitchen prefers, may choose more and are prompted to enter their Credit Card information to pay for the additional meals. Customers may also edit their personal information without having to contact the kitchen. Customers may enter the Member Area and View their Menu Details. From this point the customer may select any session (past or future) and view details regarding their menu selections.

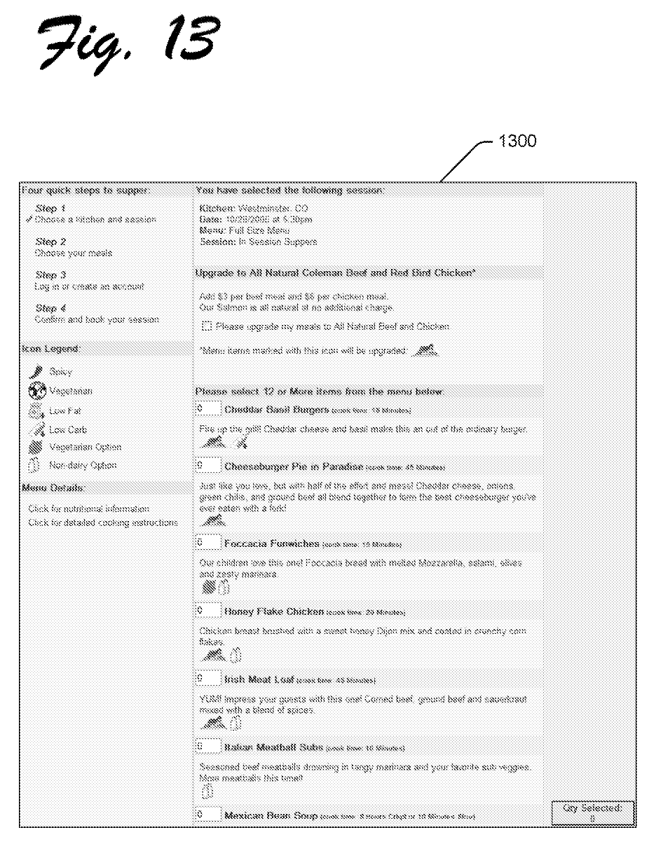

FIG. 13 is a screenshot showing an exemplary Menu Selection area 1300 that may be displayed for a customer. Each kitchen may have a separate menu or transition from monthly menus independently from each other or all at the same time based on preferences setup by HQ. The menu page provides session details, Upgrade/Customer options, etc.

Meal selection may include a text box or a drop down on the Menu Selection area 1300 which enables the customer to select individual meals. Each meal may be configured with a maximum amount that the customer may choose, (e.g., to manage margins). The counter at the bottom of the screen keeps track of the customer's choices. The counter turns green when the customer has reached the minimum number of meals for the package selected.

Optionally, steps may be integrated into the system to show the customer how many steps are required to complete the order and enable the customer to jump back and forth from step to step.

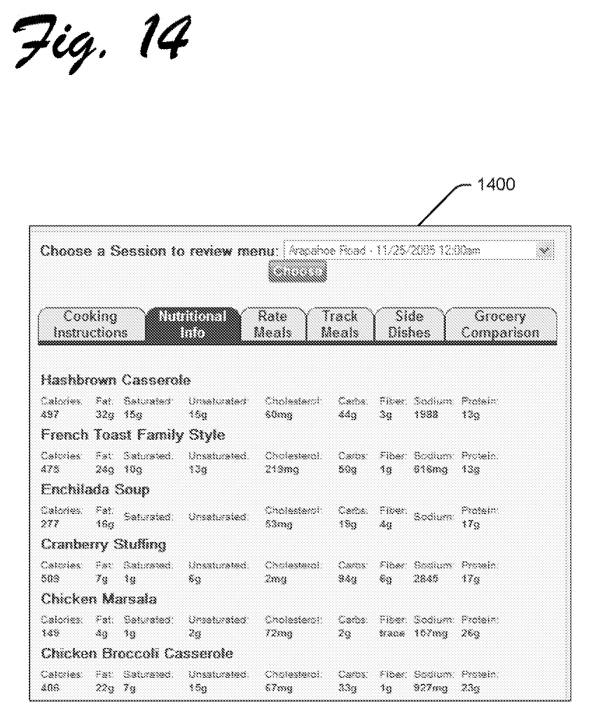

FIG. 14 is a screenshot showing an exemplary Menu Review display 1400 that may be displayed for a customer. Here, customers may view Cooking Instructions, Nutritional Information, rate meals (providing more information for both the kitchen and customer), view past reviews as a reminder of what the customer really enjoyed and would order again, view suggested Side Dishes (e.g., when the customer is at work and needs to pick up a side dish on the way home), view Grocery Comparisons (e.g., to show them how much money and time the customer saved by using the kitchen service), rate a meal (e.g., provides customer feedback and provides the customer a way to keep track of their favorite meals).

The menu area may dynamically pull data from the database, such as, nutritional information and Cooking Instructions (optional Weight Watchers Points or other diet systems). There is also an option to set and display cooking methods, (e.g., Thaw and Serve meal, Grill, Oven, and BBQ) each defined for individual meals by the owner.

Before continuing, it is noted that the systems shown and described above with reference to the figures are merely exemplary of systems which may be implemented for online menu and food preparation, and are not intended to be limiting.

By way of illustration, a Gift Certificate system may be run manually or automatically. In one such embodiment, each kitchen may create its own Gift Certificate numbers or the system may generate a number. The system tracks where the Gift Certificate was sold, the number, the amount, the status, date of issue, date used, and location used. This information enables reconciling payments between kitchens to account for Gift Certificates.

By way of further illustration, promotional codes may be added to the system. Exemplary promotions may include free X number of meals after Y number of meals has been ordered; X % off order when a certain amount has been reached or a certain number of meals ordered; $X off order when a certain amount has been reached or a certain number of meals ordered; free additional item (side dish, etc.). In addition, promotions may be company-wide (or franchise-wide) applying to all kitchens, and/or kitchen-specific (franchise-specific) applying only to specific kitchens or franchises.

Still other features may include built-in error checking and user warnings. For example, an email invite system may be implemented so that customers can invite friends to join them at a specific session or invite them to a private party at the kitchen. In order to better plan, the system may ask the customer if the customer is bringing guests with them to the session.

A Member area may also be provided to add value for customers. The Member area serves to bring customers back to the kitchen's website and makes customers part of an online community, creating loyalty and recurring registrations. In an exemplary embodiment, the system displays the Member area screen after a customer has logged in. From the Member area, customers can sign up for a session, edit their Personal Information, view their Upcoming Session information, change menu options for an upcoming session (e.g., if the session is at least 72 hours in the future), view their Meal Details, etc.

The system may also include Integrated Reminders and ‘Touching’ customers more than once. In an exemplary embodiment, the system automatically generates a Reminder email 2 Days before a session. The email is sent to the customer reminding the customer of their Session, the time, location, and any additional notes/reminders. This email includes a map to the kitchen and a link to a map service, such as, Mapquest or Yahoo! Maps, and also Kitchen information, After a customer has attended a session (e.g., 25 days later) the customer receives an automated reminder email to remind them that their freezer may be running low on meals. The customer is shown the current month's menu or the next month's menu depending on their last session date. The customer is also given a link to register or sign up for a session (and registrants from this link may be tracked for ROI purposes).

Still additional features enable the owner to customize the site contents and make the system match the ‘look and feel’ of the kitchen. For example, a Menu Preview area may links to a full menu. The Contact area and FAQ area may be automatically updated. Pricing is customizable and may be implemented company-wide or on a kitchen-by-kitchen basis. Newsletters may also be provided and feed directly into the kitchen database and/or third party newsletter services.

A Point of Sale system may also be provided. The Point of Sale system may be completely web based, supporting a credit card swiping machine and receipt printer, as well as Cash, Check, Gift Cards, Gift Certificates, and Manual Card entry. Receipts may be auto generated and printed on standard paper printers, receipt printers, or emailed directly to the customer. The point of sale system (can be used without any hardware or with card swiper and receipt printer) and integrates with Inventory Management and Financial reports.

Still other embodiments of systems for online menu and food preparation are also contemplated, as will be readily appreciated by those having ordinary skill in the art after becoming familiar with the teachings herein.

Exemplary Operations

Exemplary operations are disclosed which may be implemented for online menu and food preparation. The operations may be embodied as logic instructions on one or more computer-readable medium. When executed on a processor, the logic instructions cause a general purpose computing device to be programmed as a special-purpose machine that implements the described operations in an exemplary implementation, the components and connections depicted in the figures may be used.

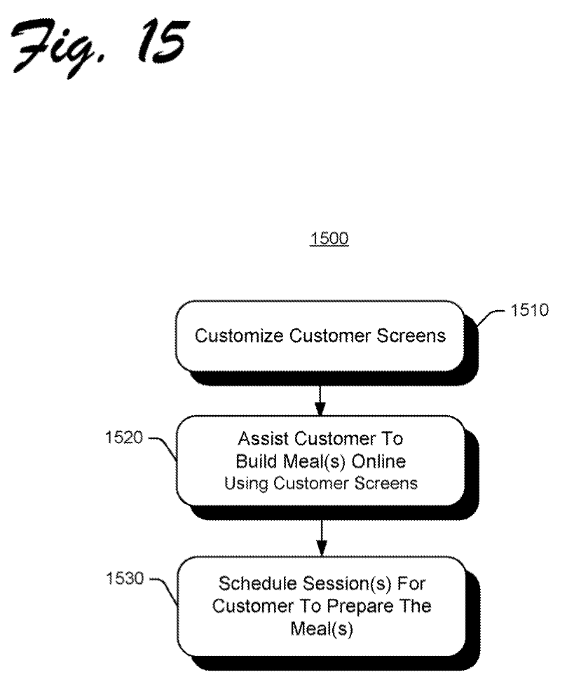

FIG. 15 is a flowchart illustrating exemplary operations 1500 which may be implemented for online menu and food preparation. In operation 1510, e.g., the software product may be used to assist an owner of a kitchen business to at least partially customize the plurality of customer screens. In operation 1520 the customer screens are used to assist a customer of the kitchen business to build a meal online. In operation 1530, the customer screens are used to schedule a session for the customer to come prepare the meal at a physical location of the kitchen business.

The operations and examples shown and described with reference to FIG. 15 are provided to illustrate exemplary implementations for online menu and food preparation systems and methods. It is noted that the operations are not limited to the ordering shown. Still other operations may also be implemented.

It is understood that the embodiments shown and described herein are intended only for purposes of illustration of exemplary systems and methods and are not intended to be limiting. In addition to the specific embodiments explicitly set forth herein, other aspects and implementations will be apparent to those skilled in the art from consideration of the specification disclosed herein.

1. A system for online menu and food preparation comprising:
a database for storing and retrieving data related to a kitchen business;
a host computer operatively associated with the database;
program code executing at least in part on the host computer, the program code displaying a plurality of customer screens based at least in part on the data stored in the database and at least in part on data received from a customer, the plurality of customer screens assisting the customer to build a meal online and schedule a session far the customer to come prepare the meal at a physical location of the kitchen business.

2. The system of claim 1 wherein the program code requires the customer to build a minimum number of meals online before scheduling a session for the customer to come prepare the meals.

3. The system of claim 1 further comprising program code executing at least in part on the host computer, the program code displaying a plurality of owner screens based at least in part on the data stored in the database and at least in part on data received from an owner of the kitchen business, the plurality of owner screens assisting the owner to at least partially customize the plurality of customer screens.

4. The system of claim 3 wherein the plurality of owner screens assists the owner as part of an integrated product to manage inventory, marketing, operations, ordering, delivery, sales, and franchise development/tracking for the kitchen business.

5. The system of claim 1 wherein the program code generates reports for the kitchen business.

6. The system of claim 1 wherein the program code manages special event sessions.

7. A computer-program product for online menu and food preparation comprising:
program code for storing and retrieving data in a database;
program code for receiving data from a customer;
program code for displaying a plurality of customer screens based at least in part on the data stored in the database and at least in part on data received from a customer, the plurality of customer screens assisting the customer to build a meal online; and
program code for scheduling a session for the customer to come prepare the meal at a physical location of the kitchen business.

8. The computer-program product of claim 7 further comprising flexible program code for maintaining either company-wide pricing for all of a plurality of kitchen businesses, per-kitchen pricing, or per-meal pricing.

9. The computer-program product of claim 7 further comprising program code for displaying a plurality of owner screens based at least in part on the data stored in the database and at least in part on data received from an owner of the kitchen business, the plurality of owner screens assisting the owner to at least partially customize the plurality of customer screens.

10. The computer-program product of claim 9 wherein the program code is fully integrated as an off-the-shelf software product.

11. The computer-program product of claim 7 further comprising program code as part of an integrated product for managing inventory, marketing, operations, ordering delivery, sales, and franchise development/tracking for the kitchen business.

12. The computer-program product of claim 7 further comprising program code for generating reports for the kitchen business.

13. A method for online menu and food preparation comprising:
assisting an owner of a kitchen business to at least partially customize the plurality of customer screens;
using the customer screens to assist a customer of the kitchen business to build a meal online; and
using the customer screens to schedule a session for the customer to come prepare the meal at a physical location of the kitchen business.

14. The method of claim 13 further comprising assisting the owner of the kitchen business managing inventory, marketing, operations, ordering, delivery, and franchise development/tracking for the kitchen business.

15. The method of claim 13 further comprising automatically generating reports for the kitchen business based on customer interaction.

16. The method of claim 13 further comprising showing at least one of the following for a meal: cooking instructions, cooking methods, nutritional information, suggested side dishes, and icon/text descriptions to represent various attributes of the meal.

17. The method of claim 13 further comprising showing customer ratings for a meal.

18. The method of claim 13 further comprising generating at least one report for the owner based on customer interaction with the kitchen business.

19. The method of claim 13 further comprising automatically generating an email for the customer reminding the customer of the scheduled session.

20. The method of claim 13 further comprising automatically generating an email for the customer reminding the customer to eat at least one meal from a session prior to an upcoming session.

21. The method of claim 13 further comprising generating at least one upgrade path.

22. The method of claim 21 wherein the at least one upgrade path is for a user to upgrade meals to at least one of the following: “All Natural Meat,” or “Whole Wheat.”

23. The method of claim 21 further comprising determining which meals the upgrade path applies to and automatically charging an Upgrade Fee for those meals.
